(19) United States
(12) Patent Application Publication
(10) Pub. No.: US 2020/0313491 A1
(43) Pub. Date: Oct. 1, 2020

(54) GENERATORS AND METHODS OF MAKING GENERATORS

(71) Applicant: Hamilton Sundstrand Corporation, Charlotte, NC (US)

(72) Inventors: Joseph Kenneth Coldwate, Roscoe, IL (US); Dhaval Patel, Loves Park, IL (US); Andreas C. Koenig, Rockford, IL (US)

(21) Appl. No.: 16/363,603

(22) Filed: Mar. 25, 2019

(51) Int. Cl. H02K 3/46; H02K 21/14; H02K 1/22; H02K 1/27

(52) U.S. Cl. CPC H02K 3/46; H02K 1/2793; H02K 1/223; H02K 21/14

(57) ABSTRACT

A generator includes a stator with a stator winding, a rotor core with a rotor tooth supported for rotation relative to the stator about a rotation axis, and a field winding. The field winding includes a field coil that is seated on the rotor tooth. The field coil includes two or more flat wire turns stacked with one another and formed such edges of the field coil tightly engage circumferential faces of the tooth. Electrical systems and methods of making generators are also described.

### BACKGROUND

The subject matter disclosed herein generally relates to generators, and more particularly to generator with rotor windings formed from flat wire.

Electrical systems, such as aircraft electrical systems, commonly include generators. The generators provide electrical power to electrical devices connected to the electrical systems during operation, typically by rotating a rotor carrying a magnetic element relative to a stator winding. As the rotor rotates relative to the stator the magnetic elements communicate magnetic flux to the stator. The magnetic flux in turn induces an electric current in the stator winding, which is harvested from the stator winding and communicated to electrical devices connected to the generator.

The magnetic elements carried by the rotor typically include permanent magnets, windings, or both permanent magnets and windings. In the case of generators employing wound field rotors, an electric excitation current is applied to the windings to generate and/or tune the magnetic flux communicated by the rotor. The windings are generally formed with a wire having a rounded or circular cross-sectional profile. The geometry of the rotor is typically selected to accommodate mechanical load exerted on the rotor by the windings during rotation as well as to limit density of the magnetic flux communicated between the magnetic elements carried and the stator winding.

Such generators and methods of making generators having generally been satisfactory for their intended purpose. However, there remains a need in the art for improved generators and methods of making generators. The present disclosure provides a solution to this need.

### BRIEF SUMMARY

According to one embodiments a generator is provided. The generator includes a stator with a stator winding, a rotor core supported for rotation relative to the stator about a rotation axis, the rotor core having one or more axially extending rotor tooth, and a field winding. The field winding includes one or more field coil seated on the rotor core and extending about the rotor tooth. The field coil includes two or more flat wire turns radially stacked with one another and formed such edges of the field coil tightly engage circumferential faces of the tooth.

In addition to one or more of the features described above, or as an alternative, further embodiments may include that a flat wire turn stack defined by the plurality of flat wire turns is one (1) flat wire-width wide.

In addition to one or more of the features described above, or as an alternative, further embodiments may include that the flat wire has an axial profile with a height and a width, wherein the width of the flat wire is greater than the height of the flat wire.

In addition to one or more of the features described above, or as an alternative, further embodiments may include that the flat wire has an axial profile that is rectangular in shape.

In addition to one or more of the features described above, or as an alternative, further embodiments may include that the flat wire turns are oblique relative to the rotor tooth, a first edge of the flat wire abutting the rotor tooth being arranged radially outward of an opposite second edge of the flat wire.

In addition to one or more of the features described above, or as an alternative, further embodiments may include that the field winding has twelve (12) field coils circumferentially distributed about a periphery of the rotor core.

In addition to one or more of the features described above, or as an alternative, further embodiments may include that the field coil has a first axial portion abutting a first circumferential face of the rotor tooth, a second axial portion abutting a second circumferential face of the rotor tooth, the second circumferential face circumferentially separated from the first circumferential face by the rotor tooth, and end turn portion. The end turn portion couples the first axial portion to the second axial portion and is bowed radially outward of the first axial portion and the second axial portion to tightly abut the first axial segment and the second axial segment against the rotor tooth.

In addition to one or more of the features described above, or as an alternative, further embodiments may include that the rotor tooth is a first rotor tooth and the rotor core defines a second rotor tooth circumferentially separated from the first rotor tooth by an axial slot, the generator further including a second field coil extending about the second rotor tooth, and a rotor wedge arranged in the axial slot and separating the first field coil from the second field coil.

In addition to one or more of the features described above, or as an alternative, further embodiments may include a damper coil seated in the rotor tooth and arranged radially outward of field coil.

In addition to one or more of the features described above, or as an alternative, further embodiments may include a shaft arranged along the rotation axis, wherein the rotor core is seated on the shaft.

In addition to one or more of the features described above, or as an alternative, further embodiments may include that the rotor tooth is a first rotor tooth and the rotor core has a second rotor tooth separated by a gap, wherein a minimum width of gap is substantially equivalent to a width of the flat wire turn.

In addition to one or more of the features described above, or as an alternative, further embodiments may include that the rotor tooth defines a pole arc, wherein the pole is larger than a pole arc of a rotor having an equivalent pole pitch and a field coil formed from wire having a circular profile.

In addition to one or more of the features described above, or as an alternative, further embodiments may include that the field coil comprises twenty (20) flat wire turns stacked with one another.

According to another embodiment an electrical system is provided. The electrical system includes a generator as described above and two or more electrical devices electrically connected to the stator winding. A flat wire turn stack defined by the two or more flat wire turns is one (1) flat wire wide, the flat wire has an axial profile with a height and a width, and the width of the flat wire is greater than the height of the flat wire.

In addition to one or more of the features described above, or as an alternative, further embodiments may include that the field winding includes twelve (12) field coils circumferentially distributed about a periphery of the rotor core wherein the field coil comprises twenty (20) flat wire turns stacked with one another.

In addition to one or more of the features described above, or as an alternative, further embodiments may include that the flat wire turns are stacked with one another radially relative the rotation axis; and wherein the flat wire turns are oblique relative to the rotor tooth, a first edge of the flat wire abutting the rotor tooth being arranged radially outward of an opposite second edge of the flat wire.

According to further embodiments a method of making a generator is provided. The method includes stacking two or more flat wire turns to form a field coil, seating the field coil on a tooth of a rotor core, forming the field coil on the rotor core such that the edges of the field coil tightly engage circumferential faces of the tooth, and supporting the rotor core for rotation about a rotation axis relative to a stator with a stator winding.

In addition to one or more of the features described above, or as an alternative, further embodiments may include that forming the field coil includes bowing an end turn portion of the field coil radially outward relative to axial segments of the field coil.

In addition to one or more of the features described above, or as an alternative, further embodiments may include positioning a rotor wedge on a side of the field coil opposite the tooth.

Technical effects of embodiments of the present disclosure include the capability to form rotors with large pole arc size in relation to rotors of equivalent diameter and pole count formed with wire having rounded or circular cross-sectional shapes. In certain embodiments generators described herein can communicate a given amount of magnetic flux with lower flux density owing to the relatively large pole arc in comparison to rotors of equivalent diameter and pole count. In accordance with certain embodiments, generators described herein can operate with relatively low tooth stress in comparison to generators employing rounded or circulate wire for a given rotor diameter and rotational speed, improving generator efficiency.

The foregoing features and elements may be combined in various combinations without exclusivity, unless expressly indicated otherwise. These features and elements as well as the operation thereof will become more apparent in light of the following description and the accompanying drawings. It should be understood, however, that the following description and drawings are intended to be illustrative and explanatory in nature and non-limiting.

### BRIEF DESCRIPTION OF DRAWINGS

The following descriptions should not be considered limiting in any way. With reference to the accompanying drawings, like elements are numbered alike:

FIG. 1 is a schematic view of a generator constructed in accordance with the present disclosure, showing a rotor supported for rotation relative to a stator with a stator winding connected to a plurality of electrical devices, the generator operatively associated with a gas turbine engine to provide electrical power to the electrical devices in accordance with an embodiment of the disclosure;

FIG. 2 is cross-sectional view of the rotor shown in FIG. 1, showing a field winding with field coils formed from flat wire and seated on rotor;

FIG. 3 is a cross-sectional view of a portion of the rotor of FIG. 1, showing axial portions of the field coils extending along and abutting circumferential faces of teeth defined by the rotor;

FIG. 4 is a cross-sectional view of two field coils of seated on the generator rotor of FIG. 1, showing turns formed from flat wire and stacked radially within a slot of the rotor;

FIG. 5 is a cross-sectional view of another portion of the rotor of FIG. 1, showing formed end turn portions of the field coils formed by the flat wire stack turns, the formed end turn portions bowed radially outward relative to axial portions of the field coils; and

FIG. 6 is a block diagram of a method of making a generator in accordance with the present disclosure, showing steps of the method.

### DETAILED DESCRIPTION

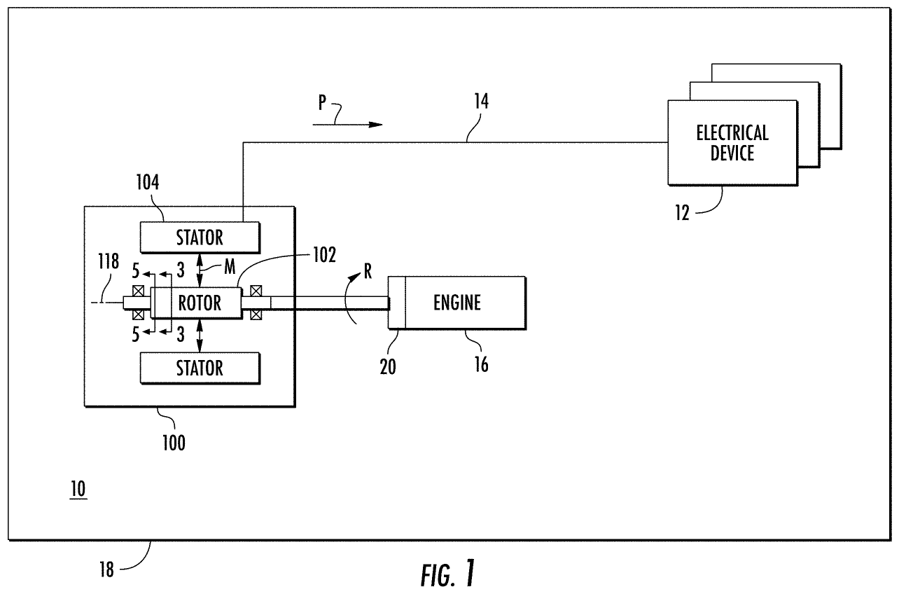

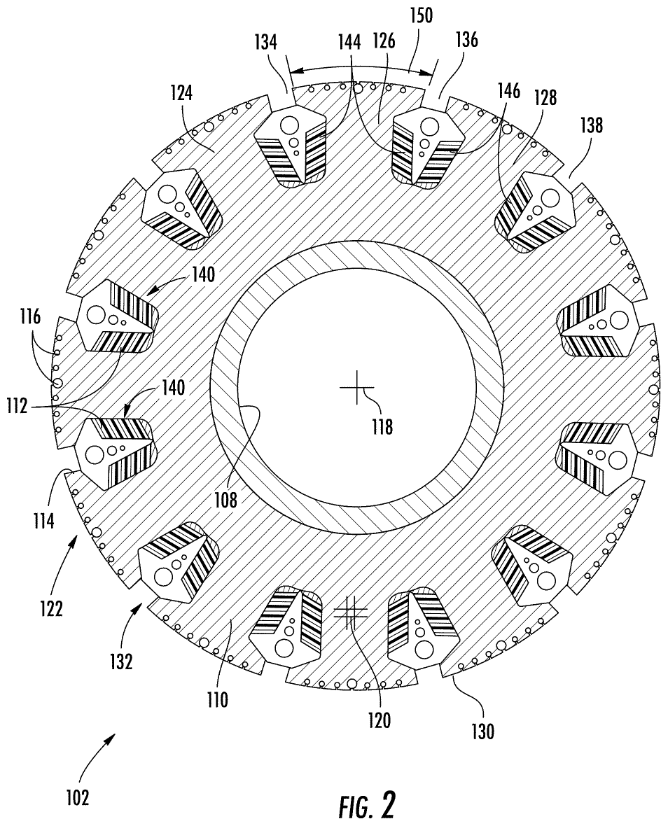

Reference will now be made to the drawings wherein like reference numerals identify similar structural features or aspects of the subject disclosure. For purposes of explanation and illustration, and not limitation, a partial view of an exemplary embodiment of a generator in accordance with the present disclosure is shown in FIG. 1 and is designated generally by reference character 100. Other embodiments of generators, electrical systems, and methods of making generators in accordance with the present disclosure, or aspects thereof, are provided in FIGS. 2-6, as will be described. The systems and methods described herein can be used for generating electrical power in aircraft electrical systems, such as in variable-frequency constant-frequency (VFCF) operatively associated with aircraft main engines and/or auxiliary power units, though the present disclosure is not limited the VFCF generators, aircraft electrical systems, or to generator-type electric machines in general.

Referring to FIG. 1, an electrical system 10, e.g., an aircraft electrical system, is shown. The electrical system 10 includes a plurality of electrical devices 12, a power bus 14, and the generator 100. The power bus 14 connects the plurality of electrical devices 12 to the generator 100. The generator 100 includes a rotor 102 supported for rotation about a rotation axis 118 relative to a stator 104 and configured to generate electrical power P using a stator winding 106 supported by the stator 104 and connected to the power bus 14, which the power bus 14 provides to the plurality of electrical devices 12 using rotation R communicated to the rotor 102 of the generator 100. As shown in FIG. 1 the rotor 102 is operatively associated with an engine 16, e.g., a main engine or an auxiliary power unit carried by an aircraft 18, and receives the mechanical rotation R through an accessory gearbox 20. Although shown and described herein as an aircraft electrical system 10, it is to be understood and appreciated that other types of electrical systems can also benefit from the present disclosure.

With reference to FIG. 2, the rotor 102 is shown. The rotor 102 includes a shaft 108, a rotor core 110, and a field winding 112. The rotor 102 also includes rotor wedges 114 and a damper winding 116. The shaft 108 arranged along a rotation axis 118 and is supported along the rotation axis 118 for rotation relative the stator 104 (shown in FIG. 1). As shown in FIG. 2 the shaft 108 is hollow and extends radially about the rotation axis 118.

The rotor core 110 is seated on the shaft 108, extends circumferentially about the shaft 108, and is fixed in rotation relative to the shaft 108 for common rotation therewith about the rotation axis 118. The rotor core 110 is formed from a magnetic material 120 for communicating magnetic flux between the rotor 102 and the stator 104 (shown in FIG. 1), such as magnetic steel. In certain embodiments the rotor core 110 includes a plurality of steel laminations axially stacked with one another along the rotation axis 118. This is for illustration purposes only and is non-limiting. As will be appreciated by those of skill in the art in view of the present disclosure, rotor 102 can be formed from sintered metallic powder or a monolithic forging, as suitable for an intended application.

The rotor core 110 has a plurality of rotor teeth 122, e.g., a first rotor tooth 124, a second rotor tooth 126, and a third rotor tooth 128. The plurality of rotor teeth 122 are circumferentially distributed about a radially outer periphery 130 of the rotor core 110. A plurality of axial gaps 132, e.g., a first axial gap 134 and a second axial gap 136, are defined about the radially outer periphery 130 and separate circumferentially adjacent teeth of the plurality of rotor teeth 122. In this respect the first axial gap 134 separates the first rotor tooth 124 from the second rotor tooth 126, and the second axial gap 136 separates the second axial gap 136 from the third rotor tooth 128.

The field winding 112 is supported by the rotor 102, is fixed in rotation relative to the rotor core 110, and is arranged about the radially outer periphery 130 of the rotor 102. The field winding 112 includes a plurality of field coils 140, e.g., a first field coil 144 and a second field coil 146, seated in the plurality of axial gaps 132 defined by the rotor core 110 and extending about respective teeth of the plurality of rotor teeth 122. The plurality of filed coils 140 are connected electrically in series with one another and are to magnetize portions of the rotor core 110 into a plurality of magnetic poles when current flows through the field winding 112 for generating the magnetic flux M (shown in FIG. 1).

The first field coil 144 extends about the first rotor tooth 124 and is disposed partially in the first axial gap 134 and the second axial gap 136. The first field coil 144 is electrically connected to the field winding 112 such that electric current flowing through the first coil magnetizes the first rotor tooth 120. This defines a first of the magnetic poles, the first rotor tooth 120 thereby communicating magnetic flux M (shown in FIG. 1) to the stator 104 across a pole arc 150 defined by the first rotor tooth 124. The second field coil 146 is similar to the first field coil 144 and additionally extends about the second rotor tooth 126, is disposed partially in the second axial gap 136 and the third axial gap 138, and defines a second magnetic pole when current flows through the field winding 112. As shown in FIG. 2 the field winding 112 includes twelve (12) field coils 140. The twelve (12) field coils 140 in turn, when current is applied to the field winding 112, define twelve (12) magnetic poles which are distributed circumferentially about the radially outer periphery 130 of the rotor 102. The twelve (12) poles allow the generator 100 to cooperate with power conversion electronics arranged to condition the voltage waveform output from 12-pole generators while enjoying relatively low flux density and/or higher power density provided by the generator 100, as will be described.

As will be appreciated by those of skill in the art in view of the present disclosure, the construction of field windings in electric machines can influence both the mechanical stress exerted on the rotor structure and the characteristics of magnetic flux communicated in electric machines. For example, gaps between rotor teeth typically must be sized to allow the field winding to be installed in the electric machine rotor. The size of the gaps between adjacent rotor teeth cooperates with the pole count and rotor diameter to determine both the geometry of the rotor teeth and the pole arc size in the electric machine.

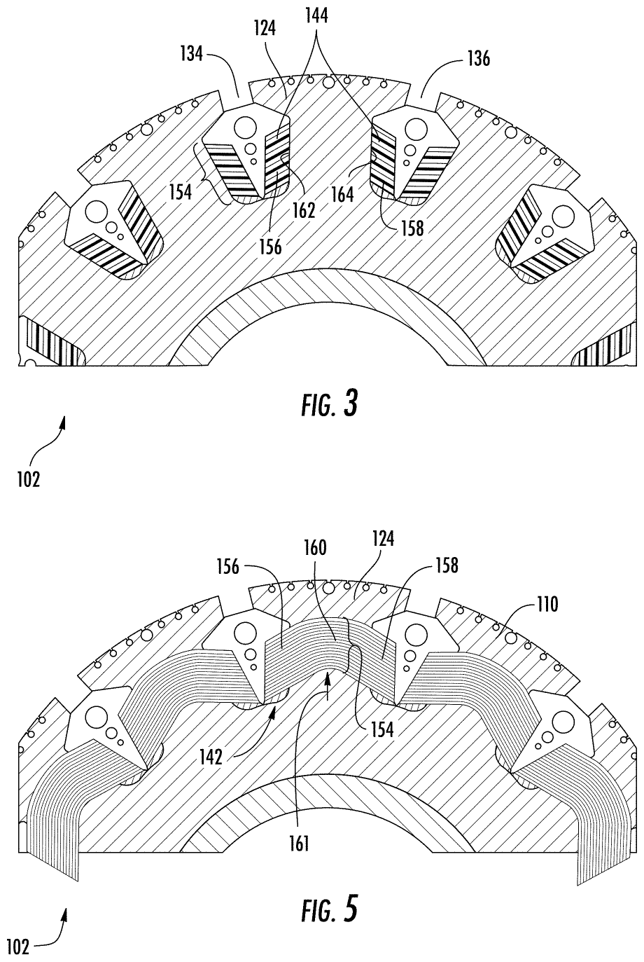

As will also be appreciated by those of skill in the art in view of the present disclosure, pole arc size influences magnetic flux density, the maximum amount of magnetic flux linking the rotor and stator in the electric machine, and/or the shape of the voltage waveform associated with the magnetic flux communicated between the stator and rotor in the electric machine. Applicant has determined that employment field windings constructed from flat wire turns 154 (shown in FIG. 3), in contrast to the rounded (e.g., circular) wires typically employed in field windings, can limit the amount of stress exerted on the rotor teeth in relation to turns formed from wire having round or circular shapes. Flat wire can also allow for rotor poles to have relatively large pole arc size in comparison to turns formed from wire having round or circular shapes, limiting the density of magnetic flux communicated between the rotor and stator. Limited flux density can in turn increase the power density of the generator compared to generators employing wire having rounded or circular shapes and/or improve characteristics of the voltage waveform associated with the magnetic flux communicated between the rotor and the stator in such generators.

With reference to FIG. 3, a portion of the rotor 102 including the flat wire turns 154 is shown. Each of the plurality of field coils 140 forming the field coil 112 (shown in FIG. 2) include two axial portions and an end turn portion. In this respect the first field coil 144 includes a first axial portion 156 and a second axial portion 158 coupled to one another by an end turn portion 160 (shown in FIG. 5).

The first axial portion 156 is arranged in the first axial gap 134 and circumferentially abuts the first rotor tooth 124. More specifically, the first axial portion 156 abuts a first circumferential face 162 of the first rotor tooth 124 and is defined by the flat wire turns 154. The second axial portion 158 is similar to the first axial portion 156 and is additionally arranged in the second axial gap 136 such that the second axial portion 158 also abuts the first rotor tooth 124 along a second circumferential face 164, the second circumferential face 164 located on a side of the first rotor tooth 124 circumferentially opposite the first circumferential face 162.

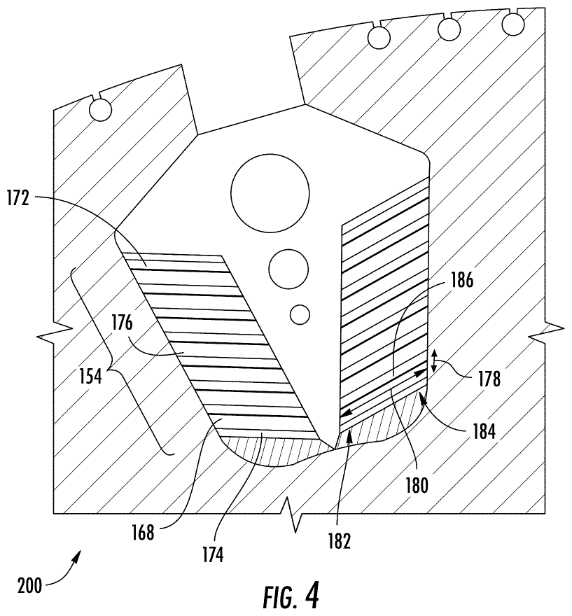

With reference to FIG. 4, the flat wire turns 154 include a plurality of flat wires 168 radially stacked to form a flat wire turn stack 170. In this respect the first axial portion 152 of the first field coil 142 includes a radially outer flat wire 172 radially stacked with a radially inner flat wire 174 and a radially intermediate flat wire 176 in the flat wire turn stack 170. The radially outer flat wire 172 defines an axial profile with a height 178 and a width 180, the width 180 being larger than the height 178 of the radially outer flat wire 172. In certain embodiments the radially outer flat wire 172 has a substantially rectangular axial profile 186, two corners of the substantially rectangular axial profile 186 being acute and two corners of the substantially rectangular axial profile being obtuse. The radially inner flat wire 166 and the radially intermediate flat wire 176 are similar to the radially outer flat wire 172, and are arranged such that widths of each are substantially parallel to the width 180 of the radially outer flat wire 172.

The radially outer flat wire 172 is angled relative to the first rotor tooth 124. More specifically, the radially outer flat wire 172 is angled obliquely relative to a radial axis defined by the first rotor tooth 124 such that a first end 182 of the axial profile abutting the first rotor tooth 124 is located radially outward of an opposite second end 184 of the radially outer flat wire 172. The radially inner flat wire 166 and the radially intermediate flat wire 176 are similarly angled relative to the first rotor tooth 124, which aligns the first axial portion 152 with the end turn portion 160 of the first field coil 144. As shown in FIG. 5, the first axial portion 152 of the first field coil 144 is one wire wide, i.e., a single flat wire circumferentially interposed between the rotor wedge 114 and the first rotor tooth 124. As also shown in FIG. 5 the flat wire turn stack 170 includes twenty (20) flat wires, which provided electrical resistance commensurate with coils formed from wires having a cylindrical profile in a generator having a rotor of similar diameter.

With reference to FIG. 5, the end turn portion 160 is shown. The end turn portion 160 circumferentially spans the first rotor tooth 124 and couples the first axial portion 156 of the first field coil 144 (shown in FIG. 4) to the second axial portion 158 (shown in FIG. 4) of the first field coil 144 (shown in FIG. 3). Further, the end turn portion 160 is bowed 161 radially outward from the first axial portion 152 and the second axial portion 158. In this respect the end turn portion 160 traces an arcuate path including the flat wire turns 154 of the flat wire turn stack 170 that circumferentially couples the second axial portion 158 to the first axial portion of the first field coil 142. It is contemplated that the bow 161 be introduced subsequent to installation of the first field coil 142 in the rotor core 110, in a forming operation, the forming operation and associated bow 161 tightening the first field coil 142 against the first rotor tooth 124. Each of the plurality of the field coils 140 are similar in this respect, axial portions of each of the plurality of the field coils 140 are coupled by a respective end turn portion. As will be appreciated by those of skill in the art in view of the present disclosure, the forming operation loads the field coils in tension, tightens the field coils against tooth the field coil extends about, and increase the resistance to centrifugal force that the circumferential faces of the tooth exerted on the field coil by the tooth.

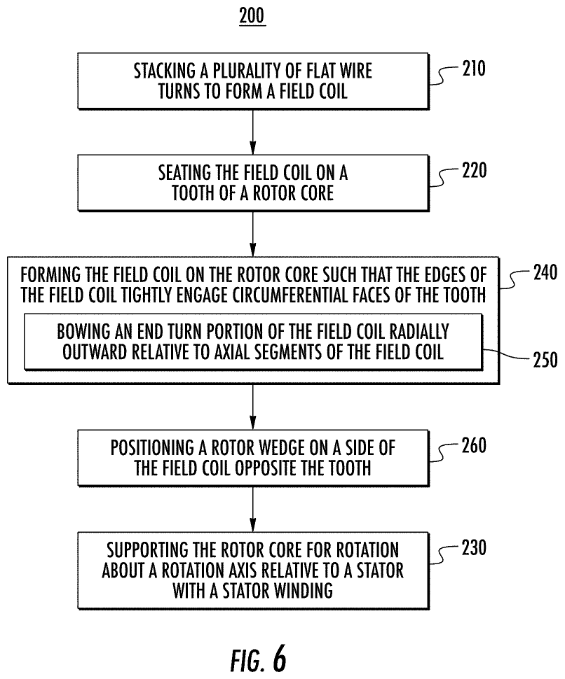

With reference to FIG. 6, a method 200 of making a generator, e.g., the generator 100 is shown. As shown with box 210, a plurality of flat wire turns, e.g., the flat wire turns 154 (shown in FIG. 3), are stacked with one another to form a field coil, e.g., the first field coil 142. The field coil is then seated on a rotor tooth of a rotor for a generator, e.g., the first rotor tooth 124 (shown in FIG. 2) of the rotor 102 (shown in FIG. 1), as shown with box 220. The rotor is then supported for rotation along a rotation axis, e.g., the rotation axis 118 (shown in FIG. 2), as shown with box 230. It is contemplated that the rotor be supported for rotation relative to stator with a winding, e.g., the stator 104 (shown in FIG. 1) with the stator winding 106 (shown in FIG. 1), as also shown with box 230.

It is contemplated that the field coil undergo a forming operation such that edges of the field coil tightly abut circumferential faces of the rotor tooth, as shown with box 240. In certain embodiments the forming the field coil can include bowing the field coil such that an end turn portion, e.g., the end turn portion 160 (shown in FIG. 5), of the field coil extends radially outward from axial segments of the field coil, e.g., the first axial portion 152 (shown in FIG. 3) and the second axial portion 158 (shown in FIG. 3), as shown with box 250. As shown with box 260, a rotor wedge, e.g., the rotor wedge 114 (shown in FIG. 2), is positioned on a side of the field coil opposite the rotor tooth.

Field coils for generators can be formed with wires having circular cross-sections. The circular cross-section of the wire forming the field coils influence the pole arc of generator rotors including the field coils, the pole arc in turn being a factor in density of flux communicated between the rotor and the stator. The pole arc in turn can also influence the peak magnetic flux that can be communicated between the rotor and the stator and rotor construction due to the stress associated with the field winding placement and shape.

In embodiments described herein field coils include flat wire turns stacked with one another. The flat wire turns allow the pole arc defined by the rotor to be relatively large for a given pole count and rotor diameter, limiting density of magnetic flux communicated by the rotor and providing relatively high peak magnetic flux communication capability and/or improving quality of the voltage waveform associated with the magnetic flux communicated between the rotor and stator. In accordance with certain embodiments, the field coils can be formed such that field coil end turns are bowed radially outward relative to axial portions of the field coils, tightening the field coils against the teeth about which the respective field coil is seated. It is also contemplated that the field coils can have a width that such the field coils can be installed over the tooth tips that define the relatively large pole arcs of the rotor teeth.

The term “about” is intended to include the degree of error associated with measurement of the particular quantity based upon the equipment available at the time of filing the application. For example, “about” can include a range of ±8% or 5%, or 2% of a given value.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the present disclosure has been described with reference to an exemplary embodiment or embodiments, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the claims.

What is claimed is:

1. A generator, comprising:
a stator with a stator winding;
a rotor core supported for rotation relative to the stator about a rotation axis, the rotor core having one or more axially extending rotor tooth; and
a field winding with one or more field coil seated on the rotor core and extending about the rotor tooth, wherein the field coil includes a plurality of flat wire turns radially stacked with one another and formed such edges of the field coil tightly engage circumferential faces of the tooth.

2. The generator as recited in claim 1, wherein a flat wire turn stack defined by the plurality of flat wire turns is one (1) flat wire-width wide.

3. The generator as recited in claim 1, wherein the flat wire has an axial profile with a height and a width, wherein the width of the flat wire is greater than the height of the flat wire.

4. The generator as recited in claim 1, wherein the flat wire has an axial profile that is rectangular in shape.

5. The generator as recited in claim 1, wherein the flat wire turns are oblique relative to the rotor tooth, a first edge of the flat wire abutting the rotor tooth being arranged radially outward of an opposite second edge of the flat wire.

6. The generator as recited in claim 1, wherein the field winding comprises twelve (12) field coils circumferentially distributed about a periphery of the rotor core.

7. The generator as recited in claim 1, wherein the field coil comprises:
a first axial portion abutting a first circumferential face of the rotor tooth;
a second axial portion abutting a second circumferential face of the rotor tooth, the second circumferential face circumferentially separated from the first circumferential face by the rotor tooth; and
an end turn portion coupling the first axial portion to the second axial portion, wherein the end turn portion is bowed radially outward of the first axial portion and the second axial portion to tightly abut the first axial segment and the second axial segment against the rotor tooth.

8. The generator as recited in claim 1, wherein the rotor tooth is a first rotor tooth and the rotor core defining a second rotor tooth circumferentially separated from the first rotor tooth by an axial slot, the generator further comprising:
a second field coil extending about the second rotor tooth; and
a rotor wedge arranged in the axial slot and separating the first field coil from the second field coil.

9. The generator as recited in claim 1, further comprising a damper coil seated in the rotor tooth and arranged radially outward of field coil.

10. The generator as recited in claim 1, further comprising a shaft arranged along the rotation axis, wherein the rotor core is seated on the shaft.

11. The generator as recited in claim 1, wherein the rotor tooth is a first rotor tooth and the rotor core has a second rotor tooth separated by a gap, wherein a minimum width of gap is substantially equivalent to a width of the flat wire turn.

12. The generator as recited in claim 1, wherein the rotor tooth defines a pole arc, wherein the pole is larger than a pole arc of a rotor having an equivalent pole pitch and a field coil formed from wire having a circular profile.

13. The generator as recited in claim 1, wherein the field coil comprises twenty (20) flat wire turns stacked with one another.

14. An electrical system, comprising:
a generator as recited in claim 1, wherein a flat wire turn stack defined by the plurality of flat wire turns is one (1) flat wire wide wherein the flat wire has an axial profile with a height and a width, wherein the width of the flat wire is greater than the height of the flat wire; and
a plurality of electrical devices electrically connected to the stator winding.

15. The electrical system as recited in claim 14, wherein the field winding comprises twelve (12) field coils circumferentially distributed about a periphery of the rotor core wherein the field coil comprises twenty (20) flat wire turns stacked with one another.

16. The electrical system as recited in claim 14, wherein the flat wire turns are stacked with one another radially relative the rotation axis; and wherein the flat wire turns are oblique relative to the rotor tooth, a first edge of the flat wire abutting the rotor tooth being arranged radially outward of an opposite second edge of the flat wire.

17. A method of making a generator, comprising:
stacking a plurality of flat wire turns to form a field coil;
seating the field coil on a tooth of a rotor core;
forming the field coil on the rotor core such that the edges of the field coil tightly engage circumferential faces of the tooth; and
supporting the rotor core for rotation about a rotation axis relative to a stator with a stator winding.

18. The method as recited in claim 17, wherein forming the field coil comprises bowing an end turn portion of the field coil radially outward relative to axial segments of the field coil.

19. The method as recited in claim 17, further comprising positioning a rotor wedge on a side of the field coil opposite the tooth.
